(19) United States
(12) Patent Application Publication
(10) Pub. No.: US 2025/0168855 A1
(43) Pub. Date: May 22, 2025

(54) Multi-Slot PDCCH Monitoring Search Space Configuration

(71) Applicant: Apple Inc., CUPERTINO, CA (US)

(72) Inventors: Oghenekome OTERI, San Diego, CA (US); Dawei ZHANG, Saratoga, CA (US); Hong HE, San Jose, CA (US); Huaning NIU, San Jose, CA (US); Wei ZENG, Saratoga, CA (US); Yushu ZHANG, Beijing (CN)

(21) Appl. No.: 18/837,347

(22) PCT Filed: Feb. 11, 2022
(86) PCT No.: PCT/CN2022/076066

§ 371 Date: Aug. 9, 2024

(51) Int. Cl. H04W 72/23; H04W 72/0446

(52) U.S. Cl. CPC H04W 72/23; H04W 72/0446

(57) ABSTRACT

A user equipment (UE) configures a first search space (SS) set of a first slot group for multi-slot physical downlink control channel (PDCCH) monitoring (MSM) and a second SS set of a second slot group for MSM. The second SS set comprises a first type of common search space (CSS) limited to a maximum number of locations. The UE then performs MSM using the first SS set and the second SS set.

### TECHNICAL FIELD

The present disclosure generally relates to communication, and in particular, to multi-slot PDCCH monitoring search space configuration.

### BACKGROUND

In a Fifth Generation (5G) New Radio (NR) network, for communication above 52.6 Giga hertz (GHz), the subcarrier spacing (SCS) may be increased to provide robustness to phase noise. For example, the SCS may be set to 120 kilo hertz (kHz), 480 kHz or 960 kHz. However, increasing the SCS may result in a reduction in the duration of the symbol which may place an unreasonable strain on user equipment (UE) processing resources during physical downlink control channel (PDCCH) monitoring. It has been identified that multi-slot PDCCH monitoring may be used to improve the efficiency of PDDCH monitoring for communication above 52.6 GHz.

### SUMMARY

Some exemplary embodiments are related to a processor of a user equipment (UE) configured to perform operations. The operations include configuring a first search space (SS) set of a first slot group for multi-slot physical downlink control channel (PDCCH) monitoring (MSM) and configuring a second SS set of a second slot group for MSM. The second SS set comprises a first type of common search space (CSS) limited to a maximum number of locations. The operations also include performing MSM using the first SS set and the second SS set.

Other exemplary embodiments are related to a processor of a base station configured to perform operations. The operations include transmitting multi-slot physical downlink control channel (PDCCH) monitoring (MSM) parameters to a user equipment (UE). The UE utilizes multiple slot groups to perform MSM and a search space (SS) set for a type of slot group comprises a first type of common search space (CSS) limited to a maximum number of locations. The operations also include transmitting information to the UE on the PDCCH.

Still further exemplary embodiments are related to a user equipment (UE) having a transceiver configured to communicate with a network and a processor communicatively coupled to the transceiver and configured to perform operations. The operations include configuring a first search space (SS) set of a first slot group for multi-slot physical downlink control channel (PDCCH) monitoring (MSM) and configuring a second SS set of a second slot group for MSM. The second SS set comprises a first type of common search space (CSS) limited to a maximum number of locations. The operations also include performing MSM using the first SS set and the second SS set.

Additional exemplary embodiments are related to a base station having a transceiver configured to communicate with a user equipment (UE) and a processor communicatively coupled to the transceiver and configured to perform operations. The operations include transmitting multi-slot physical downlink control channel (PDCCH) monitoring (MSM) parameters to a user equipment (UE). The UE utilizes multiple slot groups to perform MSM and a search space (SS) set for a type of slot group comprises a first type of common search space (CSS) limited to a maximum number of locations. The operations also include transmitting information to the UE on the PDCCH.

### BRIEF DESCRIPTION OF THE DRAWINGS

FIG. 1 shows an exemplary set of slot groups within a subframe according to various exemplary embodiments.

FIG. 2 shows an example arrangement of Group 1 and Group 2 slot groups according to various exemplary embodiments.

FIG. 3 shows an exemplary network arrangement according to various exemplary embodiments.

FIG. 4 shows an exemplary user equipment (UE) according to various exemplary embodiments.

FIG. 5 shows an exemplary base station according to various exemplary embodiments.

FIG. 6 shows examples of Group 2 search space (SS) locations over multiple slot groups in accordance with the exemplary SS configuration complexity reduction techniques.

FIG. 7 shows a table with a control channel element (CCE) aggregation level and a corresponding number of physical downlink control channel (PDCCH) candidates.

### DETAILED DESCRIPTION

The exemplary embodiments may be further understood with reference to the following description and the related appended drawings, wherein like elements are provided with the same reference numerals. The exemplary embodiments relate to enabling multi-slot physical downlink control channel (PDCCH) monitoring (MSM).

As will be described in more detail below, the exemplary embodiments introduce various techniques for enabling MSM in a 5G network. In one aspect, the exemplary embodiments relate to MSM search space (SS) configuration complexity reduction. In another aspect, the exemplary embodiments relate to a blind detection (BD)/control channel element (CCE) budget for MSM. The exemplary techniques introduced herein may be used independently from one another, in conjunction with currently implemented MSM mechanisms, in conjunction with future implementations of MSM mechanisms or independently from other MSM mechanisms.

The exemplary embodiments are described with regard to a user equipment (UE). However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any electronic component.

In a Fifth Generation (5G) New Radio (NR) network, for communication above 52.6 Giga hertz (GHz), the subcarrier spacing (SCS) may be increased to provide robustness to phase noise. For example, the SCS may be set to 120 kilo hertz (kHz), 480 kHz or 960 KHz. However, increasing the SCS may result in a reduction in the duration of the symbol. From the perspective of the UE, the reduction in symbol duration may increase the number of operations that are to be performed by the UE for PDCCH monitoring which may place an unreasonable strain on UE processing resources.

It has been identified that it may be beneficial to utilize MSM for communication above 52.6 GHz. MSM may allow the UE to avoid the processing strain associated with other PDDCH monitoring approaches. However, while the exemplary techniques described herein may provide benefits to 5G NR communication above 52.6 GHz, the exemplary embodiments are not limited to this frequency range.

MSM may generally refer to a PDCCH monitoring approach that is based on slot groups that each comprise multiple consecutive slots. The UE may perform PDCCH monitoring within a search space (SS) during one or more slots of each slot group. To provide a general example, if a slot group comprises 4 consecutive slots, the UE may perform PDCCH monitoring during a SS within one or more slots of the 4 consecutive slots of the slot group. The UE may be configured with multiple slot groups that are each associated with the same or different frequency resources and/or overlap (fully or partially) in the time domain.

### Multi-Slot PDCCH Monitoring General Framework

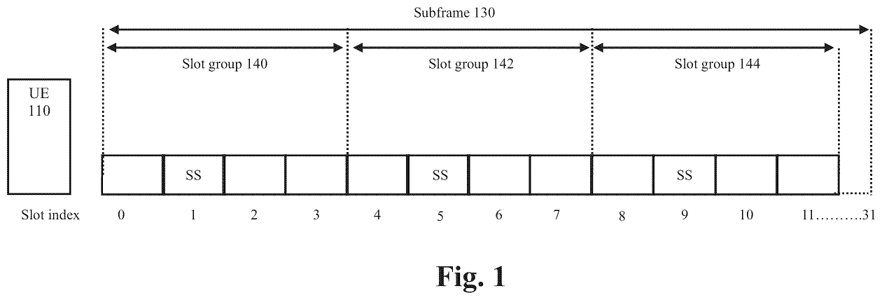

FIG. 1 shows an exemplary set of slot groups 140-144 within a subframe 130 according to various exemplary embodiments. This exemplary slot group arrangement is not intended to limit the exemplary embodiments in any way and is merely provided as a general overview of the relationship between a slot group and a subframe. A subframe may comprise 1 slot or multiple slots (e.g., 2, 4, 5, 12, 16, etc.) and the exemplary embodiments are not limited to any particular number of slots or slot groups per subframe.

The UE 110 may be configured with a PDCCH that includes multiple subframes 130. In this example, the PDCCH may be configured with a SCS of 480 kHz and 32 slots per subframe. FIG. 1 shows a portion of a subframe 130 with 12 slots indexed 0-11. This portion of subframe 130 is arranged into 3 separate slot groups 140-144 and each slot group 140-144 comprises 4 slots. There are 32 slots per subframe in this example and thus, the remaining portion of subframe 130 that is not pictured in FIG. 1 may include 20 slots indexed 12-31. The slots indexed 12-31 may be arranged into 5 separate groups each comprising a slot group size of 4 slots. Therefore, while only 3 slot groups 140-144 are shown in FIG. 1, subframe 130 may include a total 8 slot groups with a slot group size of 4 slots across its 32 slots.

In this example, the UE 110 may be configured to perform PDCCH monitoring in 1 slot from each of the slot groups 140-144. Thus, in a first slot group 140 comprising slots indexed 0-3, the UE 110 may have a PDCCH SS during slot 1. During slots indexed 0, 2 and 3, the UE 110 has the opportunity to conserve power since the UE 110 is not configured to perform PDCCH monitoring during the other slots 0, 2, 3. In a second slot group 142 comprising slots indexed 4-7, the UE 110 may have a PDCCH SS during slot 5. During slots indexed 4, 6 and 7, the UE 110 has the opportunity to conserve power since the UE 110 is not configured to perform PDCCH monitoring during the other slots 4, 6, 7. In a third slot group 144 comprising slots indexed 8-11, the UE 110 may have a PDCCH SS during slot 9. During slots indexed 8, 10 and 11, the UE 110 has the opportunity to conserve power since the UE 110 is not configured to perform PDCCH monitoring during the other slots 8, 10, 11. The UE 110 may behave in the same manner on the other 5 slot groups referenced above in the remaining portion of subframe 130 that is not pictured in FIG. 1.

Slot groups may be consecutive to one another. Thus, in this example, slot group 140 comprises slots indexed 0-3, slot group 142 comprises slots indexed 4-7 and slot group 144 comprises slots indexed 8-11. The start of a first slot group in a subframe (e.g., slot group 140) may be aligned with a slot boundary (e.g., slot index 0 (not pictured)). The start of each slot group may be aligned with a slot boundary. In this example, there is no gap between the slot groups 140-144. FIG. 1 is not intended to limit the exemplary embodiments in any way and is merely provided as a general overview of the relationship between a slot group and a subframe. The exemplary embodiments may apply to any appropriate SCS, subframe duration, number of slots per subframe, number of slot groups, slot group size, etc.

A control resources set (CORESET) may be defined and based on the CORESET a SS may be defined. The UE 110 may perform PDCCH monitoring within the SS. The following examples provide a general overview of SSs within the slot group framework.

Throughout this description, reference is made to “Group 1” to identify a first set of consecutive slot groups and “Group 2” to identify a second set of consecutive slot groups. Those skilled in the art will understand that MSM Group 1 and Group 2 may be defined in third generation partnership program (3GPP) Specifications. The exemplary embodiments may utilize Group 1 and Group 2 in accordance with the manner in which these terms are defined in 3GPP documents and may be modified in accordance with the exemplary embodiments described herein.

The UE 110 may perform PDCCH monitoring within a SS configured within one or more slots of each slot group. For Group 1, the SSs may include a type 1 common search space (CSS) with dedicated radio resource control (RRC) configuration, a type 3 CSS, a UE specific SS and/or any other appropriate type of SS. For Group 2, the SSs may include a type 1 CSS without dedicated RRC configuration, a type 0 CSS, a type 0A CSS, a type 2 CSS and/or any other appropriate type of SS. Thus, “Group 1” and “Group 2” may encompass different types of SSs. Specific details regarding the arrangement of a Group 1 SS set and a Group 2 SS set are provided below.

The slot group size for Group 1 may be the same as or different than the slot group size for Group 1. In addition, Group 1 and Group 2 may each be associated with the same or different frequency resources and overlap (fully or partially) in the time domain. However, any reference to a particular Group 1 and/or Group 2 arrangement is not intended to limit the exemplary embodiments in any way and is merely provided as an example. The exemplary embodiments may apply to any appropriate SCS, subframe duration, number of slots per subframe, number of slot groups, slot group size, etc.

Group 1 may consist of (Xs) consecutive slots and a SS may be configured within (Ys) consecutive slots within the Xs slots of the slot group. The location of the Ys slots within the slot group may be maintained across different slot groups. To provide an example within the context of FIG. 1, Xs may be equal to 4 (e.g., slot index 0-3) and Ys may be equal to 1. The position of the SS (e.g., Ys) in slot group 140 is the same position of the SS in slot group 142 and 144.

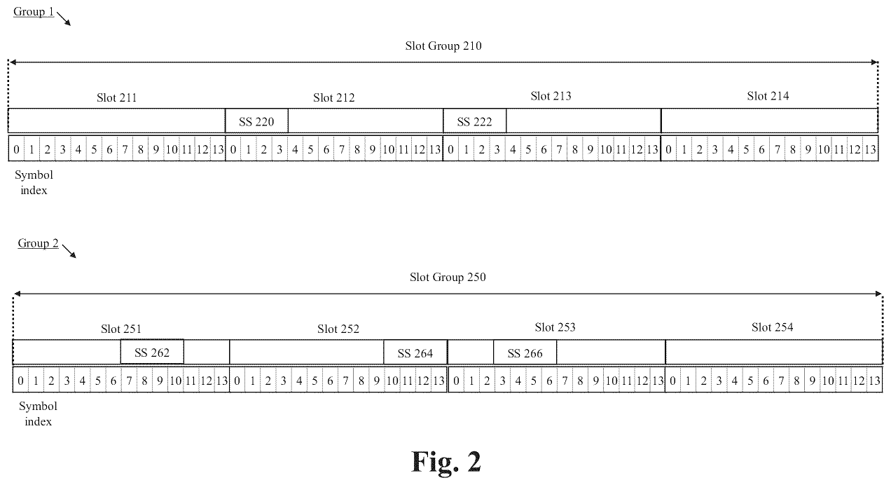

When Ys is equal to 1, the SS may be located anywhere within the Ys slot. However, the SS location may be subject to a gap-span limitation (X, Y) (e.g., release 15 (rel-15) gap-span, feature group (FG) 3-5b). For 480 kHz, the gap-span limitation (X, Y) may be (4, 3) or (7, 3) with a maximum of two monitoring spans per the Ys slot. For 960 kHz, the gap-span limitation (W, Z) may be (7, 3). An example arrangement of a Group 1 slot group is provided below with regard to FIG. 2.

When Ys is greater than 1, the SSs may be located in the first 3 symbols of each of the Ys slots. To provide an example within the context of FIG. 1, if each slot comprised symbols indexed 1-14, the SS in slot 1 of slot group 140 may be located within symbols indexed 1-3. Similarly, the SS in slot 1 of slot group 142 may be located within symbols indexed 1-3 and the SS in slot 1 of slot group 144 may be located within symbols indexed 1-3.

Group 2 may consist of (Xs) consecutive slots and a Group 2 SS may be configured anywhere within the Xs consecutive slots. However, there may be some exceptions such as, but not limited to, type 0 CSS with multiplex pattern 1 and type 0A/2 CSS with a search space ID equal to 0, where the location of the SS within the slot group is based on a particular parameter (e.g., time offset, symbol index, etc.) and/or derived based on a particular equation. An example arrangement of a Group 2 slot group is provided below with regard to FIG. 2.

FIG. 2 shows an example arrangement of Group 1 and Group 2 according to various exemplary embodiments. The example arrangement depicted in FIG. 2 is not intended to limit the exemplary embodiments in any way and is merely provided to demonstrate a general example of how the exemplary MSM framework described above may be utilized.

In this example, Group 1 is configured with a slot group that comprises (Xs=4) slots. Thus, slot group 210 includes slots 211, 212, 213 and 214. Each slot 211-214 may comprise 14 symbols indexed 0-13. Similarly, Group 2 is also configured with a slot group that comprises (Xs=4) slots. Thus, Slot group 250 includes slots 251, 252, 253 and 254. Each slot 251-254 may comprise 14 symbols indexed 0-13. In this example, the arrangement of slots in Group 1 and Group 2 are the same. However, as mentioned above, the exemplary embodiments are not limited to this arrangement and may utilize any appropriate SCS, subframe duration, number of slots per subframe, number of slot groups, slot group size, etc.

In addition, Group 1 is configured with a Group 1 SS within (Ys=2) slots. In this example, the Ys slots include slot 212 and slot 213. Since Ys is greater than 1, the SS 220 in slot 212 and the SS 222 in slot 213 may be located within the first 3 symbols of each slot (e.g., symbols indexed 0-2). Group 2 is configured with SSs in three slots 251-253. Since a Group 2 SS may be located anywhere within a slot group, the SSs 262, 264 and 266 are shown as being located within a different span of symbols for each of the slot groups 251-253. However, the exemplary embodiments are in no way limited to this Group 2 SS set configuration. This is just one possible example of a Group 2 SS set configuration and the exemplary embodiments may apply to any appropriate Group 2 configuration.

### Network Arrangement and Components

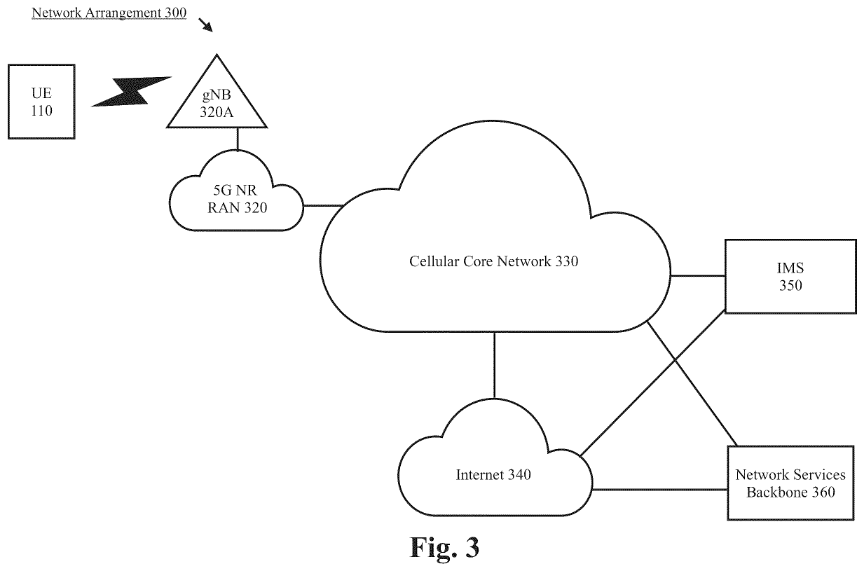

FIG. 3 shows an exemplary network arrangement 300 according to various exemplary embodiments. The exemplary network arrangement 300 includes the UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network arrangement 300, the network with which the UE 110 may wirelessly communicate is a 5G NR radio access network (RAN) 320. However, the UE 110 may also communicate with other types of networks (e.g., 5G cloud RAN, a next generation RAN (NG-RAN), a long-term evolution (LTE) RAN, a legacy cellular network, a wireless local area network (WLAN), etc.) and the UE 110 may also communicate with networks over a wired connection. With regard to the exemplary embodiments, the UE 110 may establish a connection with the 5G NR RAN 320. Therefore, the UE 110 may have a 5G NR chipset to communicate with the 5G NR RAN 320.

The 5G NR RAN 320 may be a portion of a cellular network that may be deployed by a network carrier (e.g., Verizon, AT&T, T-Mobile, etc.). The 5G NR RAN 320 may include, for example, nodes, cells or base stations (e.g., Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

Those skilled in the art will understand that any association procedure may be performed for the UE 110 to connect to the 5G NR RAN 320. For example, as discussed above, the 5G NR RAN 320 may be associated with a particular cellular provider where the UE 110 and/or the user thereof has a contract and credential information (e.g., stored on a SIM card). Upon detecting the presence of the 5G NR RAN 320, the UE 110 may transmit the corresponding credential information to associate with the 5G NR RAN 320. More specifically, the UE 110 may associate with a specific base station, e.g., the next generation Node B (gNB) 320A.

The network arrangement 300 also includes a cellular core network 330, the Internet 340, an IP Multimedia Subsystem (IMS) 350, and a network services backbone 360. The cellular core network 330 may refer an interconnected set of components that manages the operation and traffic of the cellular network. It may include the evolved packet core (EPC) and/or the 5G core (5GC). The cellular core network 330 also manages the traffic that flows between the cellular network and the Internet 340. The IMS 350 may be generally described as an architecture for delivering multimedia services to the UE 110 using the IP protocol. The IMS 350 may communicate with the cellular core network 330 and the Internet 340 to provide the multimedia services to the UE 110. The network services backbone 360 is in communication either directly or indirectly with the Internet 340 and the cellular core network 330. The network services backbone 360 may be generally described as a set of components (e.g., servers, network storage arrangements, etc.) that implement a suite of services that may be used to extend the functionalities of the UE 110 in communication with the various networks.

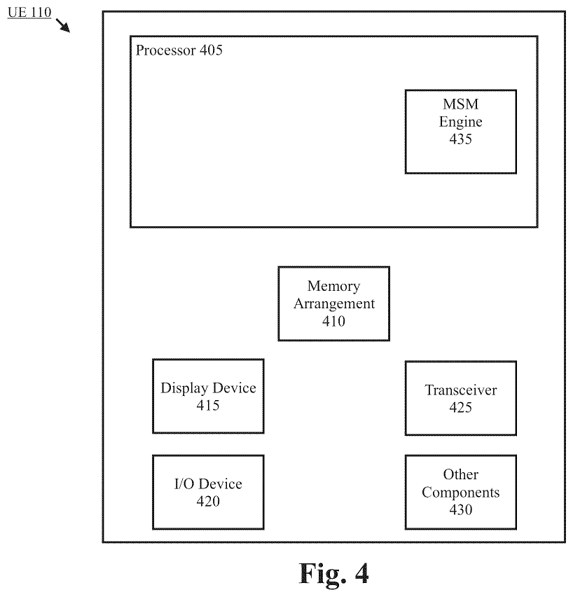

FIG. 4 shows an exemplary UE 110 according to various exemplary embodiments. The UE 110 will be described with regard to the network arrangement 300 of FIG. 3. The UE 110 may include a processor 405, a memory arrangement 410, a display device 415, an input/output (I/O) device 420, a transceiver 425 and other components 430. The other components 430 may include, for example, an audio input device, an audio output device, a power supply, a data acquisition device, ports to electrically connect the UE 110 to other electronic devices, etc.

The processor 405 may be configured to execute a plurality of engines of the UE 110. For example, the engines may include a MSM engine 435. The MSM engine 435 may perform various operations related to MSM including, but not limited to, receiving MSM parameters, identifying a location of one or more Group 1 SSs, identifying a location of one or more Group 2 SSs and monitoring MSM. In addition, the MSM engine 435 may implement the various exemplary techniques introduced herein related to search space set configuration complexity reduction and BD/CCE management.

The above referenced engine 435 being an application (e.g., a program) executed by the processor 405 is merely provided for illustrative purposes. The functionality associated with the engine 435 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 405 is split among two or more processors such as a baseband processor and an applications processor. The exemplary embodiments may be implemented in any of these or other configurations of a UE.

The memory arrangement 410 may be a hardware component configured to store data related to operations performed by the UE 110. The display device 415 may be a hardware component configured to show data to a user while the I/O device 420 may be a hardware component that enables the user to enter inputs. The display device 415 and the I/O device 420 may be separate components or integrated together such as a touchscreen. The transceiver 425 may be a hardware component configured to establish a connection with the 5G NR-RAN 320, an LTE-RAN (not pictured), a legacy RAN (not pictured), a WLAN (not pictured), etc. Accordingly, the transceiver 425 may operate on a variety of different frequencies or channels (e.g., set of consecutive frequencies).

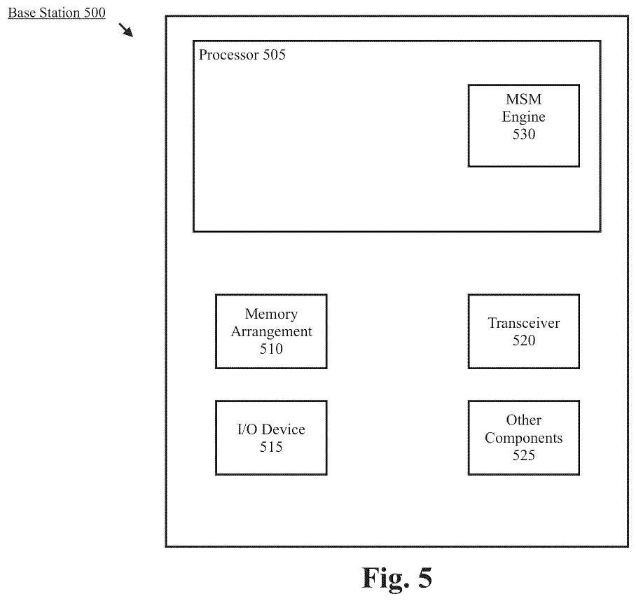

FIG. 5 shows an exemplary base station 500 according to various exemplary embodiments. The base station 500 may represent the gNB 320A or any other access node through which the UE 110 may establish a connection and manage network operations.

The base station 500 may include a processor 505, a memory arrangement 510, an input/output (I/O) device 515, a transceiver 520, and other components 525. The other components 525 may include, for example, an audio input device, an audio output device, a battery, a data acquisition device, ports to electrically connect the base station 500 to other electronic devices, etc.

The processor 505 may be configured to execute a plurality of engines for the base station 500. For example, the engines may include a MSM engine 530. The MSM engine 530 may perform various operations related to the UE 110 performing MSM including, but not limited to, signaling MSM parameters to the UE 110, receiving capability information, configuring CSSs, configuring UE specific SSs, managing a BD/CCE budget and scheduling PDCCH resources for the UE 110.

The above noted engine 530 being an application (e.g., a program) executed by the processor 505 is only exemplary. The functionality associated with the engine 530 may also be represented as a separate incorporated component of the base station 500 or may be a modular component coupled to the base station 500, e.g., an integrated circuit with or without firmware. For example, the integrated circuit may include input circuitry to receive signals and processing circuitry to process the signals and other information. In addition, in some base stations, the functionality described for the processor 505 is split among a plurality of processors (e.g., a baseband processor, an applications processor, etc.). The exemplary embodiments may be implemented in any of these or other configurations of a base station.

The memory 510 may be a hardware component configured to store data related to operations performed by the base station 500. The I/O device 515 may be a hardware component or ports that enable a user to interact with the base station 500. The transceiver 520 may be a hardware component configured to exchange data with the UE 110 and any other UE in the network arrangement 500. The transceiver 520 may operate on a variety of different frequencies or channels (e.g., set of consecutive frequencies). Therefore, the transceiver 520 may include one or more components (e.g., radios) to enable the data exchange with the various networks and UEs.

### Search Space Configuration Complexity Reduction

Under conventional circumstances, a CSS may be repeated in each slot of a slot group and in any slot group. It has been identified that this possibility may cause Group 2 SS configuration to be a high complexity task. To provide an example, consider a scenario in which the UE 110 supports monitoring Group 2 SSs in accordance with FG 3-1 within each of the Xs slots of a slot group. In this scenario, for Group 2 SSs, the monitoring occasion may be any orthogonal frequency division multiplexing (OFDM) symbols of each slot where the monitoring occasion for a type of Group 2 SS may comprise a single span of three OFDM symbols within each slot of the slot group. Thus, under conventional circumstances, Group 2 SS configuration may be a high complexity task because Group 2 SSs may occur multiple times within a slot group and over many consecutive slot groups.

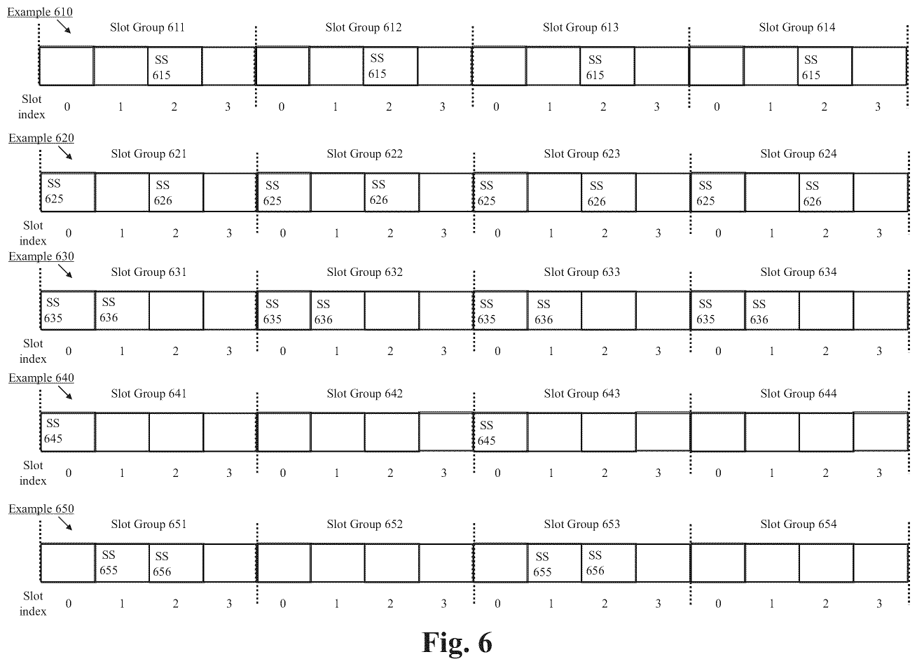

As will be described in more detail below, to limit the complexity related to Group 2 SS location across multiple slot groups, the exemplary embodiments introduce techniques that limit the number of different possibilities for Group 2 SS location. FIG. 6 described below includes examples that demonstrate how some of the exemplary techniques introduced herein to reduce Group 2 SS location complexity may be utilized.

In one approach, to limit the complexity related to Group 2 SS location across multiple slot groups, Group 2 SSs may be configured within a same slot group. For example, a Group 2 SS set may comprise three different types of SSs (e.g., type 1 CSS without dedicated RRC configuration, type 0 Css, type 0A CSS type 2 CSS) configured within a same slot group from a set of multiple consecutive slot groups (M). Thus, if (M=4), the Group 2 SSs may be configured within one slot group of the (M=4) slot groups.

In another approach, the exemplary embodiments limit a type of CSS to (N) instances per slot group where each instance of a CSS comprises multiple consecutive OFDM symbols. The value of N may be preconfigured at the UE 110, hard encoded in 3GPP Specification, set as a UE capability and/or provided to the UE 110 in any other appropriate manner.

To provide a general example, one or more types of a Group 2 SS (e.g., type 1 CSS without dedicated RRC configuration, type 0 CSS, type 0A CSS and type 2 CSS) may each be limited to N instances per slot group. In some embodiments, a first type of Group 2 SS and a second type of Group 2 SS may be limited to the same number of locations per slot group. For example, a slot group may be limited to (N=1) type 0 CSS and (N=1) type 2 CSS. In other embodiments, a first type of Group 2 CSS and a second type of Group 2 CSS may be limited to a different number of locations per slot group. For example, a slot group may include (N=1) type OA CSS and (N=2) type 1 CSS. However, these examples are merely provided for illustrative purposes, a specific type of Group 2 CSS may be limited to any appropriate number of instances per slot group.

In some embodiments, one or more types of Group 2 CSSs may be limited to (N=1) instances per slot group. It has been identified that this slot group limitation may be utilized to reduce the complexity associated with Group 2 SS configuration. In this example, a type of Group 2 CSS may be configured in accordance with n1 and N1+D. Here, n1 represents a slot location within the slot group and D represents a number of slots between each Group 2 SS. For example, when SCS is 480 kHz the value of D may equal to 4 and when SCS is 960 kHz the value of D may equal 4 or 8.

To provide one example, for 480 kHz SCS and a slot group size of 4, if a first instance of a type of Group 2 SS is located in slot group 1 then the next instance of the same type of Group 2 SS may be located in slot group 2 (e.g., N=1 per slot group). If the slot location of the first instance of Group 2 SS in slot group 1 is n1, the slot location of the next instance of the Group 2 SS is n1+4 slots which would place the SS in slot group 2.

FIG. 6 shows examples of Group 2 SS locations over multiple slot groups in accordance with the exemplary search space configuration complexity reduction techniques described herein. The examples in FIG. 6 do not depict a symbol index. However, it may be assumed that each slot of a slot group comprises the same number of symbols and a Group 2 SS spans 3 OFDM symbols.

Example 610 of FIG. 6 shows 4 slot groups 611, 612, 613 and 614 each comprising slots indexed 0-3. In this example, a type of Group 2 SS (e.g., CSS type 2, etc.) is limited to (N=1) locations per slot group. Thus, slot groups 611-614 each include a single SS 615. Within each slot group 611-614, the location of the SS 615 is located at the same slot index and the same symbol index (symbol index is not shown in FIG. 6). Although only a single type of Group 2 SS is shown in example 610, those skilled in the art will understand that Group 2 may include multiple different types of Group 2 SSs subject to the same or different limitations.

In other embodiments, one or more types of Group 2 SSs may be limited to (N>1) instances per slot group. Thus, a type of Group 2 SS may be configured in multiple slots within the slot group. In this type of configuration, the position of a type of Group 2 CSS within one or more slots (e.g., N>1) of a first slot group may be identical to the position of the same type of Group 2 CSS within in a subsequent slot group. In some embodiments, when there are multiple CSS of a same type within a single slot group (e.g., N>1), the CSSs may be limited to consecutive slots within the slot group. This may be described as a gap and span framework for Group 2 SS, where the gap is a number of slots or slots groups between a first SS of each Group 2 SS group of (Q) SSs and the span is the number of slots or slot groups for each of the Q Group 2 SS.

Example 620 of FIG. 6 shows 4 slot groups 621, 622, 623 and 624 each comprising slots indexed 0-3. In this example, a type of Group 2 SS (e.g., CSS type 2, etc.) is limited to (N>1) locations per slot group (e.g., N=2). Thus, slot groups 621-624 each include 2 SSs 625, 626. Within each slot group, the location of the SSs 625, 626 are located at the same slot index and the same symbol index (symbol index is not shown in FIG. 6). Although only a single type of Group 2 SS is shown in example 620, those skilled in the art will understand that Group 2 may include multiple different types of Group 2 SSs subject to the same or different limitations.

Example 630 of FIG. 6 shows 4 slot groups 631, 632, 623 and 634 each comprising slots indexed 0-3. In this example, a type of Group 2 SS (e.g., CSS type 2, etc.) is limited to (N>1) locations per slot group (e.g., N=2). Unlike example 620, example 630 restricts multiple CSSs within a slot group to consecutive slots. Here, since N=2, 2 consecutive slots of each slot group 631-634 include a Group 2 SS 635, 636.

In another approach, the exemplary embodiments limit a type of CSS to (P) instances per multiple consecutive slot groups (M) where each instance of the CSS comprises multiple consecutive OFDM symbols. Thus, a specific type of CSS (e.g., type 2 CSS, etc.) may be limited to P locations for a specific duration M. In the example provided above, the duration (M) is expressed as a number of consecutive slot groups. In other examples, the duration M may be expressed in slots or any other appropriate time parameter. In some embodiments, the location of P within the duration M may be fixed. The value of P and/or M may be preconfigured at the UE 110, hard encoded in 3GPP Specification, set as a UE capability and/or provided to the UE 110 in any other appropriate manner. It has been identified that this multiple slot group limitation may be utilized to reduce the complexity associated with Group 2 SS configuration.

Example 640 of FIG. 6 shows 4 slot groups 641, 642, 643 and 644 each comprising slots indexed 0-3. In this example, a type of Group 2 SS (e.g., CSS type 2, etc.) is limited to (P=1) locations per duration M where (M=2 slot groups). Thus, a single SS 645 is located within every 2 consecutive slot groups.

Example 650 of FIG. 6 shows 4 slot groups 651, 652, 653 and 654 each comprising slots indexed 0-3. In this example, a type of Group 2 SS (e.g., CSS type 2, etc.) is limited to (P=2) locations per duration M where (M=2 slot groups). In this example, the Group 2 SS are located in a pair of consecutive slots within every 2 consecutive slot groups. Thus, Group 2 SSs 645, 646 are located in consecutive slots within every 2 consecutive slot groups. However, the examples 610-650 are not intended to limit the exemplary embodiments in any way and are merely provided to illustrate how the exemplary search space configuration complexity reduction techniques may be utilized.

In another approach, Group 2 SSs may be configured across multiple slot groups but limited to one or more time windows. For instance, CSS type 0 may be related to system information block (SIB) 1, CSS type 0A may be related to SIBx and CSS type 2 may be related to paging. It has been identified that for these types of Group 2 SSs (which may be provided on a frequency band with a SCS of 480 kHz or 960 kHz) it may be beneficial for the CSS periodicity to match the CSS periodicity used when the SCS is 120 kHz. This may ensure that the wake-up period related to Group 2 SS monitoring is intermittent and does not cause an unreasonable power drain. Thus, the Group 2 SS set may be configured within one or more time windows of the multiple consecutive slot groups (M) such the Group 2 SSs align with the CSS periodicity used for a frequency band with a SCS of 120 KHz.

### BD/CCE Limits

The UE 110 may be configured with a BD/CCE budget indicating the number of blind decodes and the CCE size supported by the UE 110 per slot group. In some embodiments, the UE 110 may report the BD/CCE budget for one or more slot group sizes if the UE 110 supports a SCS associated with a particular slot group size (e.g., 120 kHz, 480 kHz, 960 kHz, etc.). In other embodiments, the UE 110 may not report a BD/CCE budget for a slot group size even if the UE 110 supports the corresponding SCS. In some embodiments, the BD/CCE budget may be hard encoded in 3GPP Specifications or predetermined in any other appropriate manner.

The exemplary embodiments relate to a slot group size of (Xs=4) and a SCS of 960 kHz. Under conventional circumstances, the BD/CCE limit for a slot group size of 4 in 960 kHz SCS may be set to 10/16. However, this may not be adequate for certain configurations. To provide an example, a type 0 SS set in a slot may consume 7 BDs and up to 28 CCEs. Thus, a BD/CCE limit of 10/16 per 4 slots may not be adequate when type 0 SS is configured which may require a BD/CCE limit of 7/28.

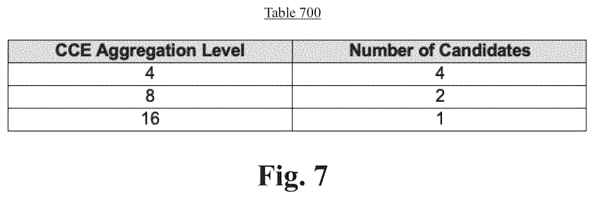

The exemplary embodiments are described with regard to a CCE aggregation level. Those skilled in the art will understand that an aggregation level may refer to a number of resource elements of a CORESET that are required to carry a downlink control information (DCI) message and may be expressed in units of CCEs. In addition, those skilled in the art will understand that a number of PDCCH candidates may be based on a corresponding CCE aggregation level. FIG. 7 shows a table 700 with a CCE aggregation level and a corresponding number of PDCCH candidates.

In one approach, when the slot group size is set to 4, the SCS is 960 kHz and the SS is a type 0 SS, only aggregation levels 4 and 8 may be supported. This would provide a BD/CCE limit of 6/12 which is less than 10/16 limit. For example, consider the table 700 with aggregation levels 4, 8 and 16, the total CCE budget for all aggregation levels may be 28 (e.g., 4+8+16) and the total BD budget for all aggregation levels is 7 (e.g., 4+2+1). As indicated above, the 10/16 limit may not be adequate for a BD/CCE of 7/28. To address this issue, the aggregation levels may be restricted to 4 and 8. The CCE budget for aggregation levels 4 and 8 is 12 (e.g., 4+8) and the BD budget for aggregation levels 4 and 8 is 6 (e.g., 4+2). Thus, the BD/CCE budget for aggregation levels 4 and 8 may be 6/12 which is less than the BD/CCE limit 10/16.

In another approach, when the slot group size is set to 4, the SCS is 960 kHz and the SS is a type 0 SS, the BD/CCE limit may be set to 7/28. The BD/CCE limit 7/28 allows for all of the aggregation levels in the table 700 to be utilized (e.g., CCE=4+8+16=28 and BD=4+2+1=7).

In another approach, when the slot group size is set to 4, the SCS is 960 kHz and the SS is a type 0 SS, the base station (e.g., gNB 320A), may indicate a preferred aggregation level. In some examples, the base station may indicate that only CCE aggregation level 16 is supported under the above referenced circumstances. Consider the table 700, the CCE/BD budget for aggregation level 16 only would be equal to 1/16 which is within the 10/16 limit. In another example, the base station may indicate that only CCE aggregation levels 4 and 8 are supported under the above referenced circumstances. Consider the table 700, the CCE/BD budget for aggregation levels 4 and 8 only would be equal to 6/12 which is within the 10/16 limit. It has been identified that other combinations of aggregation levels would exceed the 10/16 limit. Thus, the base station may indicate a preferred aggregation levels of 16 only or 4 and 8 only to ensure that the behavior is within the 10/16 limit.

In another approach, the network (e.g., gNB 320A) may configure the aggregation levels to match the CCE budget. The slot group size may be explicitly configured and thus, the network may configure the desired aggregation levels to match the CCE limit 16.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described methods may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. An apparatus comprising processing circuitry configured to:
configure a first search space (SS) set of a first slot group for multi-slot physical downlink control channel (PDCCH) monitoring (MSM);
configure a second SS set of a second slot group for MSM, wherein the second SS set comprises a first type of common search space (CSS) limited to a maximum number of locations; and
perform MSM using the first SS set and the second SS set.

2. The apparatus of claim 1, wherein the second SS set is for a plurality of second slot groups and the maximum number of locations is per each consecutive second slot group.

3. The apparatus of claim 2, wherein the maximum number of locations per each consecutive slot group is equal to 1.

4. The apparatus of claim 2, wherein the first type of CSS is further limited to consecutive slots within each of the plurality of second slot groups.

5. The apparatus of claim 2, wherein the second SS set further comprises a second different type of CSS and the maximum number of locations is for both the first type of CSS and the second type of CSS.

6. The apparatus of claim 1, wherein the second SS set is for a plurality of second slot groups and the maximum number of locations is for a subset of two or more second slot groups from the plurality of second slot groups.

7. The apparatus of claim 1, wherein the second SS set further comprises a second different type of CSS,
wherein the first type of CSS and the second type of CSS are located within a same slot of the second slot group.

8. An apparatus comprising processing circuitry configured to:
generate, for transmission to a user equipment (UE), multi-slot physical downlink control channel (PDCCH) monitoring (MSM) parameters, wherein the UE utilizes multiple slot groups to perform MSM and wherein a search space (SS) set for a type of slot group comprises a first type of common search space (CSS) limited to a maximum number of locations;
generate information for transmission to the UE on the PDCCH.

9. The apparatus of claim 8, wherein the SS set is for a plurality of consecutive slot groups of a same type and the maximum number of locations is per each consecutive slot group of the same type.

10. The apparatus of claim 9, wherein the maximum number of locations per each consecutive slot group is equal to 1.

11. The apparatus of claim 9, wherein the first type of CSS is further limited to consecutive slots within each of the plurality of consecutive slot groups.

12. The apparatus of claim 9, wherein the SS set further comprises a second different type of CSS and the maximum number of locations is for both the first type of CSS and the second type of CSS.

13. The apparatus of claim 8, wherein the SS set is for a plurality of consecutive slot groups and the maximum number of locations is for a subset of two or more slot groups from the plurality of consecutive slot groups.

14. The apparatus of claim 8, wherein a slot group size is set to 4, a subcarrier spacing (SCS) is 960 kilo hertz (kHz) and the SS set comprises a type 0 SS, and
wherein only aggregation levels 4 and 8 are supported.

15. The apparatus of claim 8, wherein a slot group size is set to 4, a subcarrier spacing (SCS) is 960 kilo hertz (kHz) and the SS set comprises a type 0 SS, and
wherein a blind detection (BD)/control channel element (CCE) limit is 7/28.

16. The apparatus of claim 8, wherein a slot group size is set to 4, a subcarrier spacing (SCS) is 960 kilo hertz (kHz) and the SS set comprises a type 0 SS, the operations further comprising:
transmitting a preferred aggregation level to the UE.

17. A user equipment (UE), comprising:
a transceiver configured to communicate with a network; and
a processor communicatively coupled to the transceiver and configured to:
configure a first search space (SS) set of a first slot group for multi-slot physical downlink control channel (PDCCH) monitoring (MSM);
configuring configure a second SS set of a second slot group for MSM, wherein the second SS set comprises a first type of common search space (CSS) limited to a maximum number of locations; and
perform MSM using the first SS set and the second SS set.

18. The UE of claim 17, wherein the second SS set is for a plurality of second slot groups and the maximum number of locations is per each consecutive second slot group.

19. The UE of claim 18, wherein the maximum number of locations per each consecutive slot group is equal to 1.

20. The UE of claim 18, wherein the first type of CSS is further limited to consecutive slots within each of the plurality of second slot groups.

21-32. (canceled)
